(19) United States
(12) Patent Application Publication
(10) Pub. No.: US 2013/0090895 A1
(43) Pub. Date: Apr. 11, 2013

(54) DEVICE AND ASSOCIATED METHODOLOGY FOR MANIPULATING THREE-DIMENSIONAL OBJECTS

(71) Applicant: Bryan Alexander ZIGHMI, Montrouge (FR)

(72) Inventor: Bryan Alexander ZIGHMI, Montrouge (FR)

(73) Assignee: DASSAULT SYSTEMES, Velizy Villacoublay Cedex (FR)

(21) Appl. No.: 13/270,705

(22) Filed: Oct. 11, 2011

(51) Int. Cl. G06F 17/50

(52) U.S. Cl. 703/1

(57) ABSTRACT

A system and associated methodology for manipulating three-dimensional objects that includes displaying at least one three-dimensional object in a scene on a display screen. One or more icons are then displayed on the display screen based on the location of the at least one three-dimensional object within the scene. Each icon corresponds to a different manipulating feature such that an icon selection is received and a corresponding manipulating feature is activated in response to the icon selection. The three-dimensional object is then manipulated based on the activated manipulating feature and the one or more manipulation icons are not displayed while the at least one three-dimensional object is being manipulated. The system and associated methodology provides a fast and efficient way of manipulating three-dimensional objects.

### FIELD

The claimed advancements relate to a device and associated methodology for manipulating three-dimensional objects in a scene.

### BACKGROUND

In industry, computer aided design (CAD) systems are used to aid in the design of three-dimensional objects by allowing designers to visualize and design a three-dimensional object before it is physically produced. In this way, a designer may determine whether the three-dimensional object is suitable for its intended application, and make necessary refinements, without having to resort to the expense of configuring equipment, making dyes and acquiring the raw materials necessary to actually make the three-dimensional object in the real word.

When visualizing and designing the three-dimensional object, designers often need to manipulate the three-dimensional object in a variety of ways in order to design the finished product. A variety of methods for manipulating three-dimensional objects have been implemented such as using an externally activated two-dimensional menu to switch separately between modes of manipulation while also using additional three-dimensional artificially created shapes within a scene to visually aid a designer in manipulating the three-dimensional object along its respective axes. Using such a method, however, prevents the designer from having immediate access to all manipulation modes at the same time because the designer has to constantly move away from the three-dimensional object to operate the externally displayed two-dimensional menu. In addition, while the additional three-dimensional artificially created shapes are designed to guide a user when manipulating a three-dimensional object along its respective axes, they tend to complicate the scene displayed on the display screen while also introducing additional operational complexity and processing requirements. Further, manipulation axes of the additional three-dimensional artificially created shapes often extend beyond the three-dimensional view of the display screen when manipulations are being performed thereby putting them outside the reach of a designer and negating their ability to aid in three-dimensional manipulation. This method is not only complicated and unintuitive for beginner users but also provides only a minimal amount of options for manipulating the three-dimensional object.

Another method for manipulating three-dimensional objects is by attaching three-dimensional manipulators, or handles, to a three-dimensional box surrounding the three-dimensional object. These handles can then be used by a user to manipulate the three-dimensional object. By using such a system, however, the designer has no clear visual identification, such as an icon, of what features the three-dimensional manipulator provides to the user and is therefore very a confusing system for new users. The three-dimensional manipulators can also appear outside the view of the display screen if the three-dimensional object is moved to the edge of the display screen thereby negating their ability to provide the designer with the functionality to manipulate the three-dimensional object using that particular three-dimensional manipulator.

### SUMMARY

A need exists for a system and associated methodology of manipulating three-dimensional objects such that manipulators always remain within the view of the display screen thereby allowing designers a variety of manipulation features regardless of the location of the three-dimensional object on the display screen. Further, the manipulation modes must be easily accessible with respect to a variety of three-dimensional objects such that three-dimensional objects can be manipulated in a faster, easier, and more varied manner while avoiding the complexity and other limitations that arise out of the conventional manipulation methods.

The following description relates to a device and associated methodology for manipulating three-dimensional objects. Specifically, the system and associated methodology for manipulating three-dimensional objects includes displaying at least one three-dimensional object in a scene on a display screen. One or more icons are then displayed on the display screen based on the location of the at least one three-dimensional object in the scene. Each icon corresponds to a different manipulating feature such that an icon selection is received and a corresponding manipulating feature is activated in response to the icon selection. The three-dimensional object is then manipulated based on the activated manipulating feature and the one or more manipulation icons are not displayed while the at least one three-dimensional object is being manipulated

### BRIEF DESCRIPTION OF THE DRAWINGS

A more complete appreciation of the present advancements and many of the attendant advantages thereof will be readily obtained as the same becomes better understood by reference to the following detailed description when considered in connection with the accompanying drawings. However, the accompanying drawings and their exemplary depictions do not in any way limit the scope of the advancements embraced by this specification. The scope of the advancements embraced by the specification and drawings are defined by the words of the accompanying claims.

FIG. 1 is a schematic diagram of a system for manipulating three-dimensional objects according to an exemplary embodiment of the present advancement;

FIG. 2 is a an algorithmic flowchart for manipulating three-dimensional objects according to an exemplary embodiment of the present advancement;

FIG. 3 is a schematic diagram of a three-dimensional object according to an exemplary embodiment of the present advancement;

FIGS. 4a-4c are step diagrams illustrating manipulation of a three-dimensional object in the scene according to an exemplary embodiment of the present advancement;

FIGS. 5a-5c are step diagrams illustrating manipulation of a three-dimensional object in the scene according to an exemplary embodiment of the present advancement;

FIGS. 6a-6c are step diagrams illustrating manipulation of a three-dimensional object in the scene according to an exemplary embodiment of the present advancement;

FIGS. 7a and 7b are step diagrams illustrating manipulation of a three-dimensional object in the scene according to an exemplary embodiment of the present advancement; and

FIG. 8 is a schematic diagram of a computer-aided design station for manipulating three-dimensional objects according to an exemplary embodiment of the present advancement.

### DETAILED DESCRIPTION

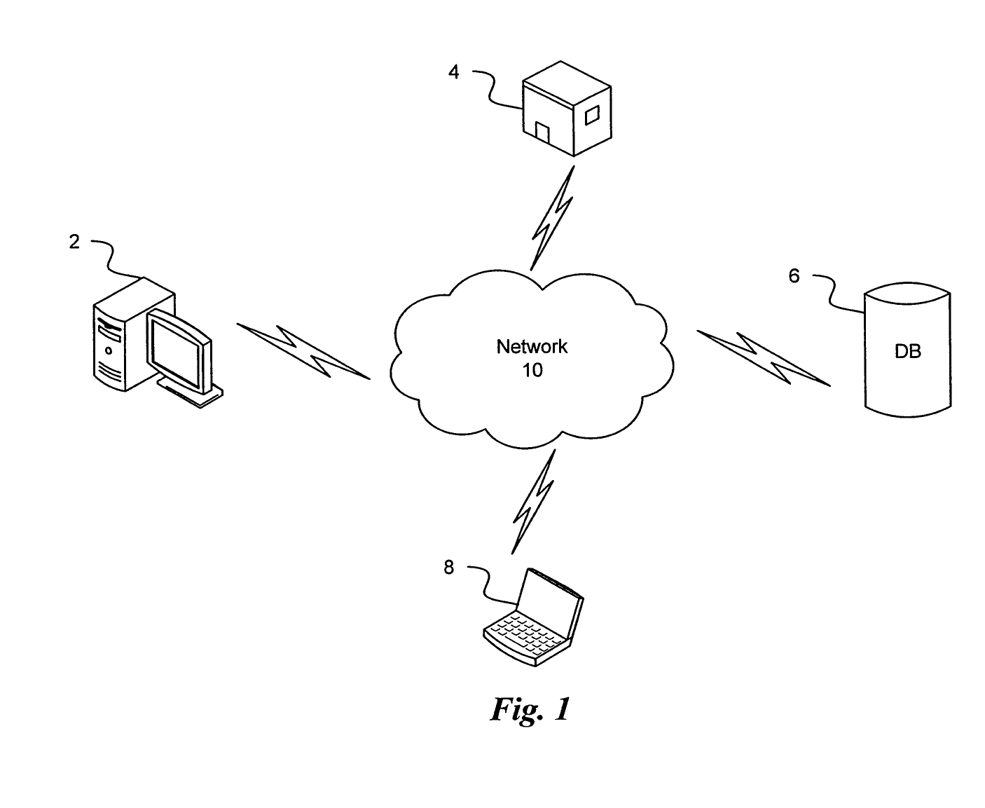

Referring now to the drawings, wherein like reference numerals designate identical or corresponding parts throughout the several views, FIG. 1 is a schematic diagram of a system for manipulating three-dimensional objects according to an exemplary embodiment of the present advancement. In FIG. 1, a computer 2, such as a CAD station, is connected to a server 4, a database 6 and a mobile device 8 via a network 10. The server 4 represents one or more servers connected to the computer 2, the database 6 and the mobile device 8 via the network 10. The database 6 represents one or more databases connected to the computer 2, the server 4 and the mobile device 8 via the network 10. The mobile device 8 represents one or more mobile devices connected to the computer 2, the server 4, and the database 6 via the network 10. The network 10 represents one or more networks, such as the internet, connected to the computer 2, the server 4, the database 6 and the mobile device 8.

The computer 2 processes and displays at least one three-dimensional object in a scene on the display screen for manipulation by a designer. The computer 2 receives inputs from a designer via an input device, such as a keyboard and/or mouse, in order to select and manipulate the three-dimensional object displayed on the display screen. Once the three-dimensional object is selected by the user via the input device of the computer 2, a plurality of manipulation icons are displayed based on the location of the three-dimensional object in the scene. A two-dimensional frame can also be displayed surrounding the three-dimensional object upon selection of the three-dimensional object such that the manipulation icons are displayed within the two-dimensional frame. One purpose of displaying the two-dimensional frame is to emphasize the selection of the three-dimensional object so that the user is informed of which three-dimensional object is selected among a set of three-dimensional objects. Each manipulation icon can be selected by the designer via the input device of the computer 2 and represents a different manipulation feature or different type of manipulation that can be performed upon the three-dimensional object. The features and functionality of the plurality of manipulation icons with respect to the three-dimensional object are described below.

The three-dimensional object displayed on the display screen of the computer 2 can be obtained from a plurality of external devices such as the server 4, the database 6 and the mobile device 8 via the network 10. The three-dimensional object can also be locally stored within the computer 2 and displayed by loading the three-dimensional object image from memory and displaying it on the display screen. Further, additional manipulation icons can be obtained via updates and/or upgrades from the server 4, the database 6 and/or the mobile device 8 via the network 10. Therefore, additional functionality and manipulation icons may be provided and the present invention is not limited to those displayed in the figures or described below.

As it would be understood by one of ordinary skill in the art and based on the teachings herein, the mobile device 8 or any other external device could also be used in the same manner as the computer 2 to manipulate three-dimensional objects. In an exemplary embodiment, a designer uses a Smartphone to manipulate three-dimensional objects on the move and/or in a mobile setting when the computer 2 is not available or is inconvenient. Optionally, the Smartphone may be used to perform updates or changes to the manipulation of the three-dimensional object prior to presenting the three-dimensional object imagery to others in an informal setting.

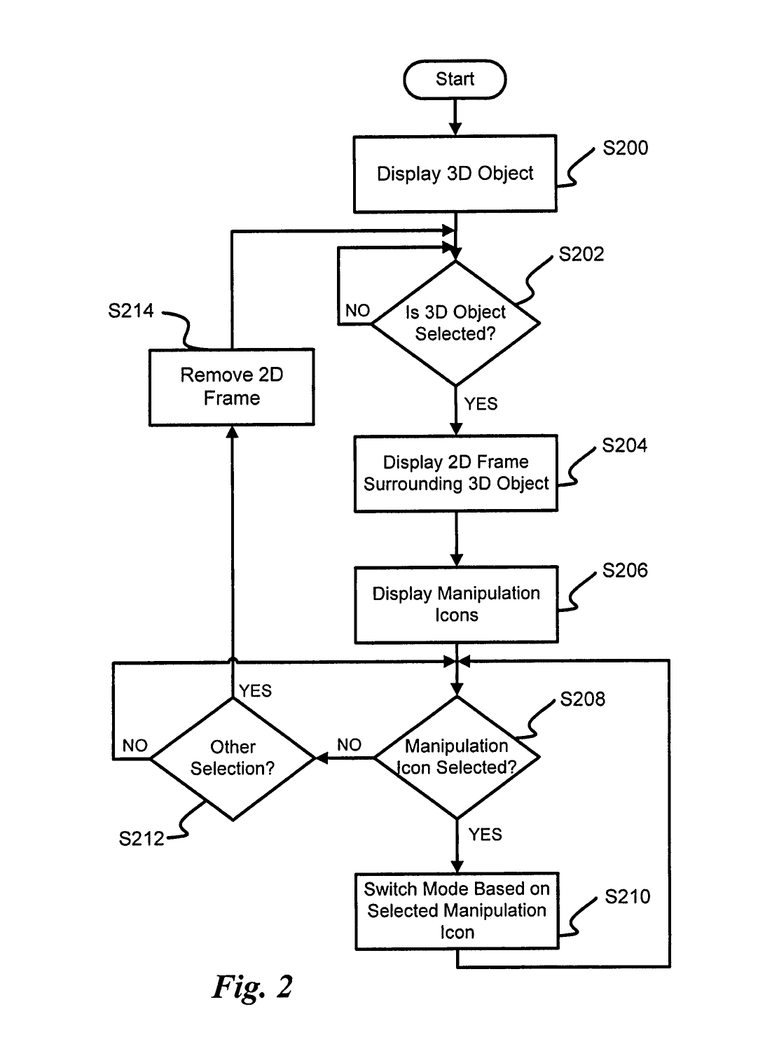

FIG. 2 is an algorithmic flowchart for manipulating three-dimensional objects according to an exemplary embodiment of the present advancement. In step S200, the computer 2 generates and displays the three-dimensional object in a scene on the display screen. The scene can represent any type of background that is displayed on the display screen in addition to the three-dimensional object. For example, in one exemplary embodiment of the present advancement, the scene includes a three-dimensionally projected image of a landscape such that a three-dimensional object appears to be located on a flat surface of the landscape itself. The scene can be changed at any time by the designer based on his design choices without affecting the three-dimensional object.

After at least one three-dimensional object is displayed in the scene on the display screen, it is determined whether the designer has selected a three-dimensional object via the input device at step S202. If the designer does not select a three-dimensional object, then the computer 2 maintains the currently displayed image of the three-dimensional object on the screen until a selection is made or a timeout occurs. In one exemplary embodiment of the present advancement, if a three-dimensional object is selected, a two-dimensional frame is generated and displayed on the display screen around the selected three-dimensional object at step S204. The two-dimensional frame can represent any type of shape that surrounding the three-dimensional object within the scene displayed on the display screen. For example, in one exemplary embodiment of the present advancement, a two-dimensional rectangle is generated and displayed such that the two-dimensional rectangle surrounds the three-dimensional object within the scene displayed on the display screen. However, as described further below, the two-dimensional frame is not required and it is possible to display only manipulation icons within close proximity or over the three-dimensional object upon selection of the three-dimensional object.

At step S206, the manipulation icons are displayed near the two-dimensional frame based on the location of the two-dimensional frame in the scene. However, the manipulation icons can also be displayed based on the location of the three-dimensional object within the scene upon selection of the three-dimensional object if the two-dimensional frame is not displayed. The manipulation icons represent different manipulation features that can be performed upon the three-dimensional object after selection by the designer via the input device. These manipulation features are described in further detail below.

At step S208, it is determined whether one of the manipulation icons has been selected by the designer. The computer 2 determines whether one of the manipulation icons has been selected based on inputs from the designer via the input device. However, as would be understood by one of ordinary skill in the art, the present advancement is not limited to these input devices and any other type of input device as would understood by one of ordinary skill in the art could be used to select the manipulation icons. If no manipulation icon is selected by the designer at step S208, the display screen continues to display the three-dimensional object and the two-dimensional frame and/or manipulation icons within the scene on the display screen and it is determined at step S212 whether an action is performed by the user other than selecting a manipulation icon or the previously selected three-dimensional object. When another action is taken by the user other than selecting a manipulation icon or the previously selected three-dimensional object, such as selecting a different three-dimensional object in the scene, the two-dimensional frame and/or manipulation icons are removed at step S214 from the scene displayed on the display screen. In the case where a different three-dimensional object is selected, a new two-dimensional frame and/or manipulation icons are generated and displayed with respect to the newly selected three-dimensional object. This provides an intuitive way for the designer to minimize screen clutter and to determine which three-dimensional object is selected while also providing manipulation icons specific to the location and selection of the different three-dimensional object. If, at step S212, the designer does not make another selection then processing returns to step S208 where it is again determined whether a manipulation icon has been selected for the originally selected three-dimensional object.

Returning to step S208, if the designer selects a manipulation icon, the computer 2 switches manipulation modes at step S210 to provide the designer with the functionality and features corresponding to the selected manipulation icon. The designer will then be able to manipulate the three-dimensional object based on the functionality provided by the selected manipulation icon until the user deselects the currently selected manipulation icon. Once a manipulation icon is selected via the input device, the three-dimensional object can be manipulated in a manner corresponding to the selected manipulation icon as long as the manipulation icon remains selected by the designer. In one exemplary embodiment of the present invention, a key or mouse button is used to select the manipulation icon and, once selected, the designer can manipulate the three-dimensional object as long as the manipulation icon remains selected by holding the key or the mouse button. In this embodiment, when the designer releases the key or mouse button, the manipulation icon is no longer selected and the three-dimensional object can no longer be manipulated until a manipulation icon is again selected by the designer.

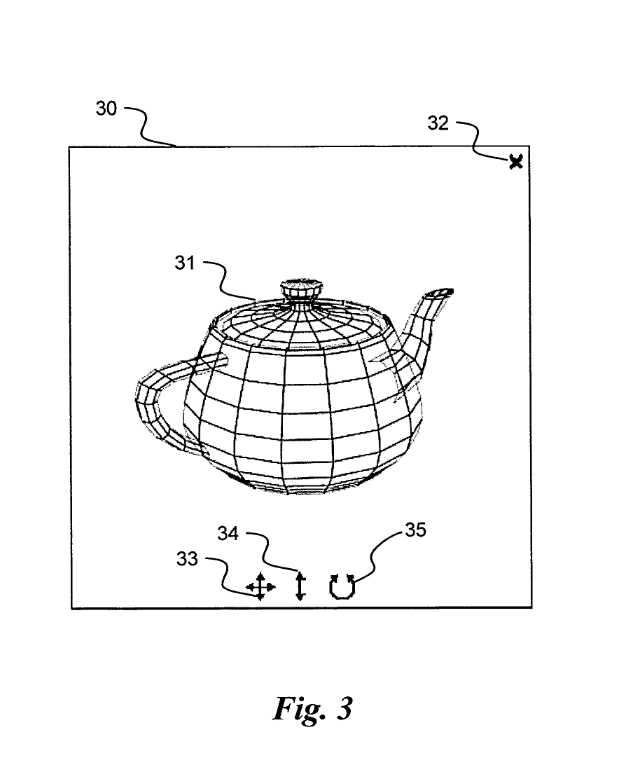

FIG. 3 is a schematic diagram of a three-dimensional object according to an exemplary embodiment of the present advancement. In FIG. 3, an example display of a three-dimensional object 31 surrounded by a two-dimensional frame 30 is illustrated. In this example of an exemplary embodiment of the present advancement, the two-dimensional frame 30 is a rectangle but the present advancement is not limited to this embodiment and the two-dimensional frame could be any shape such as a circle, square, triangle or any other shape as would recognized by one of ordinary skill in the art. In one exemplary embodiment of the present advancement, the size of the two-dimensional frame 30 is equivalent to the extent of the three-dimensional object 31 plus a selected percentage. This percentage can be varied by the designer such that the two-dimensional frame 30 can be any size as long as its surrounds the three-dimensional object 31. As such, the two-dimensional frame 30 can be sized such that there is sufficient space for the manipulation icons 32-35 to fit within the two-dimensional frame 30 while also being easily visible and separated from each other.

For the convenience of the designer, if the scene is cluttered with a plurality of three-dimensional objects 31, the two-dimensional frame 30 on a selected three-dimensional object 31 can be minimized to easily identify the selected three-dimensional object 31 while also reducing or preventing overlap with other three-dimensional objects 31 in the scene. The two-dimensional frame 30 and manipulation icons 32-35 can also be enlarged when more space within the scene is available in order to provide a more visible arrangement of the manipulation icons 32-35 within the two-dimensional frame 30.

Manipulation icons 32-35 can also be included outside of the two-dimensional frame 30 or some of the manipulation icons 32-35 may be included in the two-dimensional frame 30 while other manipulation icons 32-35 are included outside of the two-dimensional frame 30. Further, manipulation icons 32-35 can be located on the two-dimensional frame 30 itself or on the three-dimensional object 31. As such, manipulation icons 32-35 can be displayed at a particular location within the two-dimensional frame 30 or can be restricted to any location within the two-dimensional frame 30 that does not include the space occupied by the three-dimensional object 31. In one exemplary embodiment of the present advancement, the manipulation icon 32 is displayed in an upper portion of the two-dimensional frame 30 and above, to the left, to the right, or over the three-dimensional object 31 based on the size of the two-dimensional frame 31 such that the manipulation icon 32 is easily accessible to the designer while also preventing the designer from accidentally selecting the manipulation icon 32 when trying to select one of the manipulation icons 33-35. In another exemplary embodiment, the manipulation icons 33-35 can be located within the bottom portion of the two-dimensional frame 30 and can be displayed either below or over the three-dimensional object 31 based on the size of the two dimensional frame 30. In the exemplary embodiment where the two-dimensional frame 30 is not displayed when a three-dimensional object 31 is selected, the manipulation icon 32 can be displayed over an upper center, left or right hand portion of the three-dimensional object 31 and the manipulation icons 33-35 can be displayed over the three-dimensional object 31 on a lower center, left or right hand portion of the three-dimensional object 31.

The manipulation icons 32-35 can also be arranged such that groups of manipulation icons 32-35 are arranged together for easy access to the designer or each individual manipulation icon 32-35 can be displayed at a different portion within the two-dimensional frame 30 displayed on the display screen. The manipulation icons 32-35 can also be manually assigned to various locations within or without the two-dimensional frame 30 by the designer such that the designer can create a custom arrangement beneficial to his individual design needs. In one exemplary embodiment of the present advancement, and for the convenience of the designer, the manipulation icons 33-35 are displayed within the two-dimensional frame 30 in a horizontal grouping such that each of the different features provided by the different manipulation icons 33-35 are quickly accessible to the designer in an easily understandable and recognizable layout. The manipulation icons 33-35 can also be placed on a top portion of the two-dimensional frame 30 or displayed as a vertical grouping on the left or right sides of the two-dimensional frame 30 in an area occupied or not occupied by the three-dimensional object 31.

The above-noted arrangements of the manipulation icons 33-35 also apply to manipulation icons 33-35 displayed when the two-dimensional frame is not displayed. Therefore, the manipulation icons can be manually displayed at various locations or in a horizontal or vertical grouping over or near the three-dimensional object 31.

In one exemplary embodiment of the present advancement and as illustrated in FIG. 3, the three-dimensional object 31 is a wire frame sketch of a three-dimensional object that may be manipulated by the designer using the manipulation icons 32-35 included within a two-dimensional frame in the scene displayed on the display screen. However, as would be understood by one of ordinary skill in the art, the three-dimensional object 31 can be any three-dimensional object rendered and displayed on a display screen by the computer 2.

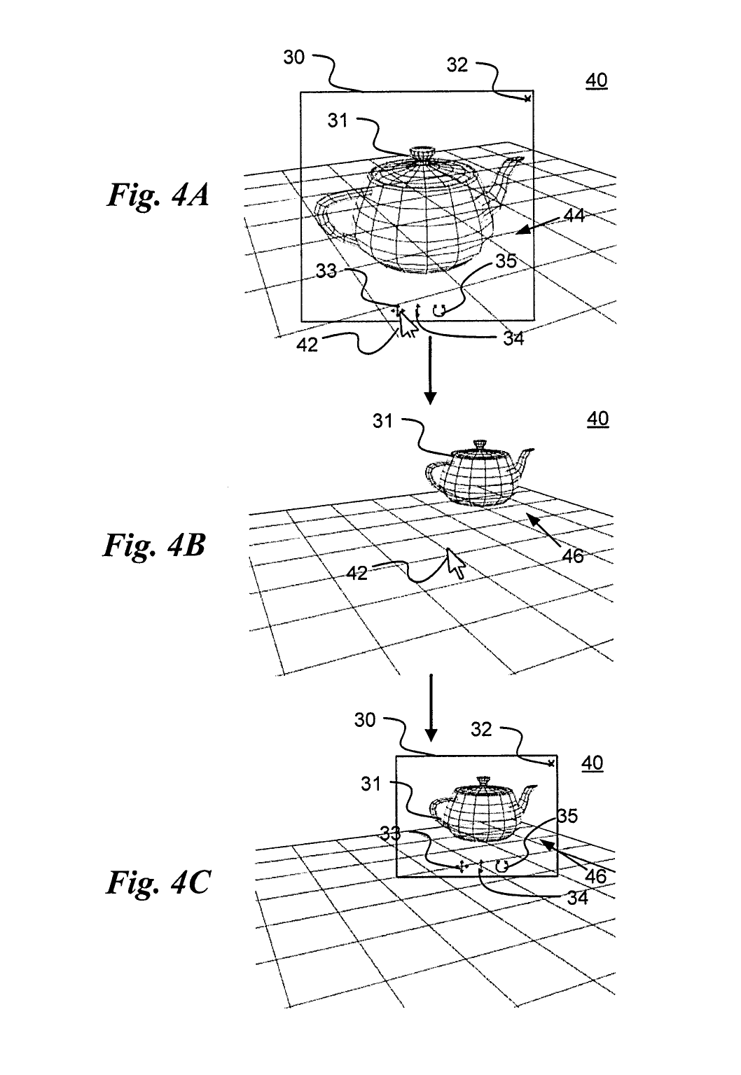

FIGS. 4A through 4C are step diagrams illustrating manipulation of the three-dimensional object 31 in a scene 40 according to an exemplary embodiment of the present advancement. In FIGS. 4A through 4C, similar items are depicted from FIG. 3 and therefore like designations are repeated. In FIG. 4A, the three-dimensional object 31 is displayed within the two-dimensional frame 30 in the scene 40. In one exemplary embodiment of the present advancement, the scene 40 represents a three-dimensional perspective view of a “floor” on which the three-dimensional object 31 is located. However, the scene 40 can be any type of image displayed on the display screen such as a “ceiling”, background or any other scene as would be understood by one of ordinary skill in the art. The scene 40 could also be blank such that the only thing displayed on the display screen is the three-dimensional object 31 within the two-dimensional frame 30.

The manipulation icons 33-35 are also displayed in FIG. 4A as being within the two-dimensional frame 30 and located at a bottom part of a two-dimensional frame 30 in a horizontal grouping. The three-dimensional object 31 is also displayed at a first position 44 within the scene 40 such that it appears “close” to the screen or view of the designer. A cursor 42 is used to select a three-dimensional object via the input device. In FIG. 4A, the designer has already selected the three-dimensional object 31 as the two-dimensional frame 30 and manipulation icons 32-35 are already displayed in the scene 40.

As illustrated in FIG. 4A, the designer selects the manipulation icon 33 via the cursor 42. The manipulation icon 33 corresponds to the translational functionality of moving the three-dimensional object 31 by selecting the manipulation icon 33 via the cursor 42 and dragging the three-dimensional object 31 to another location within the scene 40. The dragging of the three-dimensional object 31 can be performed by holding, at the same time as selecting the manipulation icon 33, the input of the input device and moving the mouse across the display screen.

As shown in FIG. 4B, when the cursor 42 is moved to drag the three-dimensional object 31 to a second position 46 within the scene 40, the two-dimensional frame 30 and/or manipulation icons 32-35 are hidden to improve the visibility within the scene 40 displayed on the display screen. Therefore, when the functionality of a selected manipulation icon is being used by the designer, the two-dimensional frame 30 and/or manipulation icons 32-35 disappear so that the designer has an easier time performing the manipulations in the scene without as many visual distractions.

In FIG. 4C, the designer stops dragging the three-dimensional object 31 via the cursor 42 and determines the second position 46 within the scene 40 in which to place the three-dimensional object 31. The speed at which the object moves can be directly related to the speed at which the cursor 42 is moved within the scene 40. Once the designer is no longer moving the three-dimensional object 31 and has positioned the three-dimensional object 31 at the second position 46, the designer stops manipulation by releasing the key or mouse button used to manipulate the three-dimensional object. At this point, the two-dimensional frame 30 and/or manipulation icons 32-35 reappear so that the designer may select additional manipulation features. As the three-dimensional object is now located at the second position 46, the two-dimensional frame 30 is now located at the second position 46 within the scene 40 to correspond to the movement of the three-dimensional object 31. Therefore, as the three-dimensional object 31 was moved further “away” from the designer on the display screen, the two-dimensional frame 30, the three-dimensional object 31 and manipulation icons 32-35 are also “moved” and displayed as being smaller than they were when the three-dimensional object 31 was in the first position 44 thereby reflecting the change based on the designer manipulation and the “floor” plane depicted in the scene. However, the two-dimensional frame 30 and the manipulation icons 32-35 can be enlarged regardless of the position of the three-dimensional object 31 on the display screen such that they are easier for the designer to see and to select different manipulation features via the cursor 42.

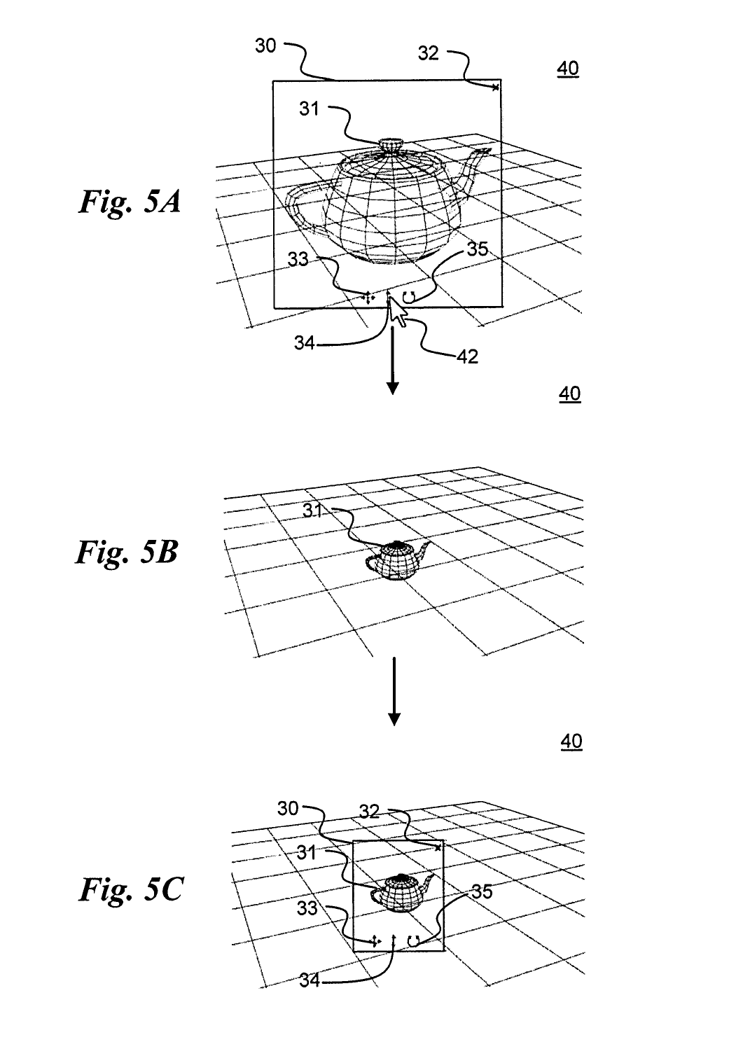

FIGS. 5A-5C are step diagrams illustrating manipulation of the three-dimensional object 31 in the scene 40 according to an exemplary embodiment of the present advancement. FIGS. 5A-5C include items identical to those displayed in previous figures and therefore like designations are repeated. As illustrated in FIG. 5A, the three-dimensional object 31 is displayed in the scene 40 within the two-dimensional frame 30 on the display screen. The designer then selects via the cursor 42 the manipulation icon 34 to manipulate the three-dimensional object 31.

The manipulation icon 34 corresponds to the functionality of scaling the three-dimensional object 31. Therefore, as shown in FIG. 5B, once the manipulation icon 34 is selected by the designer via the cursor 42, the designer can drag the cursor 42 in order to change the size of the three-dimensional object 31. Therefore, as shown in FIG. 5B, the three-dimensional object 31 shrinks to a smaller size while remaining in the same position when the designer drags the cursor 42 in a downward motion. The three-dimensional object 31 can also be increased in size by dragging the cursor 42 in an upwards motion. The speed at which the object scales is directly related to the speed at which the cursor 42 is moved within the scene 40. Additional motions as would be understood by one of ordinary skill in the art could also be used to change the size of the three-dimensional object 31. While the dragging of the three-dimensional object 31 by the designer is taking place to change the scale of the three-dimensional object 31, the two-dimensional frame 30 and/or manipulation icons 32-35 are not displayed on the display screen thereby improving the visibility within the scene 40 for the designer when making his design decisions.

FIG. 5C illustrates the three-dimensional object 31 within the scene 40 having the two-dimensional frame 30 and manipulation icons 32-35 displayed again since the designer is no longer dragging the cursor 42 after having selected the manipulation icon 34 and has completed the operation. The completion of manipulation can be accomplished by the designer by releasing the mouse button, releasing a key on the keyboard, or maintaining the cursor 42 position for a predetermined period of time. At this point, the designer has the option of selecting another manipulation icon 32-35 to again manipulate the three-dimensional object 31 or can perform other features on different three-dimensional objects 31 (not shown) within the scene 40.

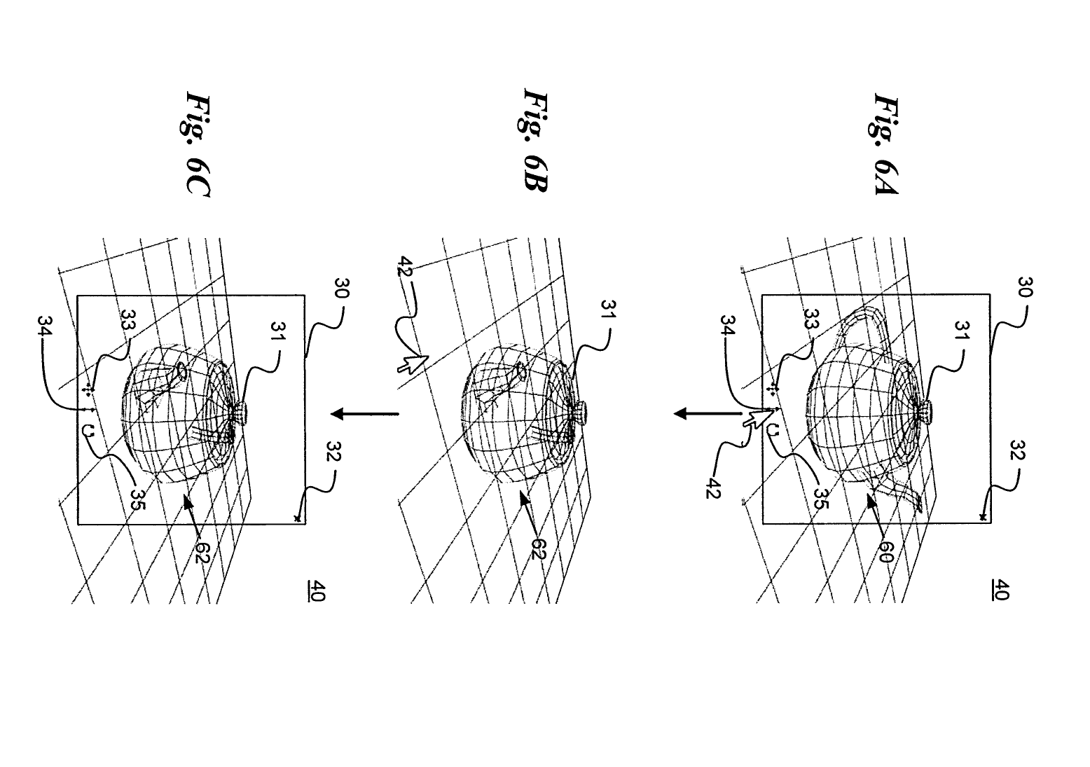

FIGS. 6A-6C are step diagrams illustrating manipulation of the three-dimensional object 31 in the scene 40 according to an exemplary embodiment of the present advancement. FIGS. 6A-6C include items identical to those described in the above-noted figures and therefore like designations are repeated. As illustrated in FIG. 6A, the designer has selected the three-dimensional object 31 as the two-dimensional frame 30 is displayed in the scene 40 on the display screen. In FIG. 6A, the designer selects via the cursor 42 the manipulation icon 35. The manipulation icon 35 corresponds to the function of rotating the three-dimensional object 31. Therefore, upon selecting the manipulation icon 35, the designer can select the three-dimensional object 31 and rotate the three-dimensional object 31 by dragging the cursor 42 in a direction of desired rotation. The rotation of the three-dimensional object 31 can be performed with respect to an axis perpendicular to the “floor” provided in the scene or can be performed respect to any other axis based on the scene. The direction of desired rotation can be any direction as would be understood by one of ordinary skill in the art. The dragging can be activated, for example, by holding a key or mouse button used to select the manipulation icon 35 and moving the cursor 42 in the direction of rotation.

In FIG. 6B, the three-dimensional object 31 is shifted from a first orientation 60 (shown in FIG. 6A) to a second orientation 62 such that the three-dimensional object 31 is rotated in a clockwise direction. As can be seen in FIG. 6B, the cursor 42 has been moved in a clockwise or left direction and as the cursor 42 moves in that direction the three-dimensional object 31 is turned to correspond to the orientation of the cursor 42 within the scene 40. The speed at which the object rotates can be directly related to the speed at which the cursor 42 is moved within the scene 40.

In FIG. 6C, the user finishes the dragging operation either by releasing a key and/or mouse button or by stopping the motion of the cursor 42 for a predetermined period of time. In response, the manipulation icons 32-35 and/or the two-dimensional frame 30 are redisplayed within the scene 40 on the display screen. The three-dimensional object 31 remains in the second orientation 62 based on the previous rotation performed via the cursor 42 by the designer after selecting the manipulation icon 35. At this point, and as described above, the two-dimensional frame 30 will remain surrounding the three-dimensional object 31 to display the manipulation icons 32-35 such that the designer can select a different manipulation icon with which to manipulate the three-dimensional object 31. If the designer chooses to perform another feature not related to the manipulation icons 33-35 displayed within the two-dimensional frame 30, the two-dimensional frame 30 and/or manipulation icons 32-35 will disappear to improve the visibility of the three-dimensional object 31 within the scene 40.

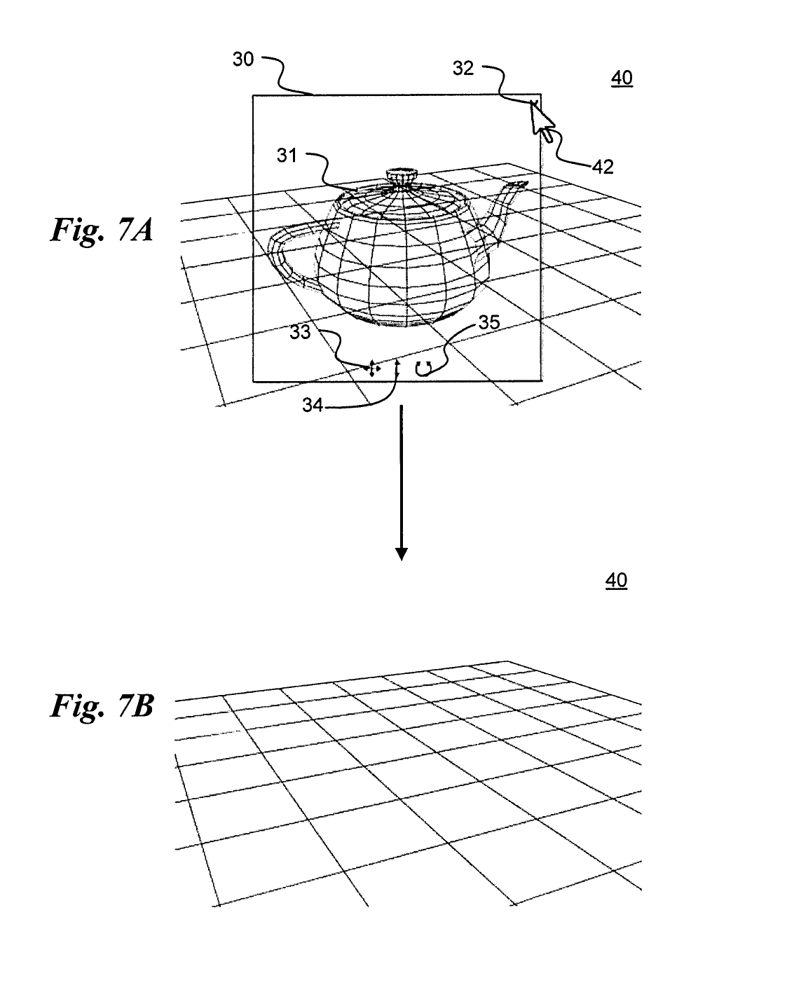

FIGS. 7A and 7B are step diagrams illustrating manipulation of the three-dimensional object 31 in the scene 40 according to an exemplary embodiment of the present advancement. FIGS. 7A includes items identical to those described in the above-noted figures and therefore like designations are repeated. As illustrated in FIG. 7A, the three-dimensional object 31 is displayed within the scene 40 and is surrounded by the two-dimensional frame 30. Manipulation icons 32-35 are also displayed within the two-dimensional frame 30 for selection by the designer. In FIG. 7A, the designer selects manipulation icon 32 via cursor 42 by moving the cursor 42 over the manipulation icon 32 and activating the input device.

The manipulation icon 32 corresponds to the function of deleting the three-dimensional object 31 from the scene 40. As can be seen in FIG. 7B, the three-dimensional object 31 is removed from the scene 40 upon selection of the manipulation icon 32 by the designer via the cursor 42. The two-dimensional frame 30 is also no longer displayed because there is no three-dimensional object 31 with which to surround. At this point, the scene 40 will remain empty until the designer decides to add an additional three-dimensional object 31 to the scene 40 for manipulation via the manipulation icons 32-35.

In the above-noted examples, there may be a plurality of three-dimensional objects 31 located within the scene 40 at the same time such that the manipulation of one three-dimensional object 31 does not affect the manipulation of other three-dimensional objects 31 or the deletion of one three-dimensional object 31 still leaves other three-dimensional objects 31 for manipulation upon selection by the designer. To improve the visibility within the scene 40, only one three-dimensional object 31 is surrounded by the two-dimensional frame 30 upon selection of the three-dimensional object by the designer via the cursor 42. However, the designer may select more than one three-dimensional objects 31 such that a plurality of two-dimensional frames 30 surround the selected three-dimensional objects 31, respectively, in order to allow the designer to quickly manipulate the three-dimensional objects 31 at the same time using different manipulation features via the manipulation icons 32-35 located separately within one of the two-dimensional frames 30. For example, the designer could select one of the manipulation icons 32-35 and manipulate all of the selected three-dimensional objects 31 in the manner discussed above based on the single selected manipulation icon 32-35. Alternatively, one two-dimensional frame 30 can surround the plurality of selected objects such that only one set of manipulation icons 32-35 is displayed and used for manipulating the plurality of selected three-dimensional objects 31 at the same time. Further, only the manipulation icons 32-35 can be displayed on the selected three-dimensional objects 31 to further improve visibility within the scene when manipulating the selected three-dimensional objects 31.

With respect to the manipulation icon 32-35 functionality described above, if the designer moves, via a manipulation icon, the three-dimensional object 31 to a portion of the scene 40 such that the three-dimensional object 31 travels outside of view of a display screen, the computer 2 prevents the two-dimensional frame 30 from moving to a position of the display screen in which manipulation icons 32-35 that are redisplayed upon deselecting the manipulation icon will no longer be visible to the designer. Therefore, the computer 2 stops the three-dimensional object 31 at the “border” of the display screen or the point at which the redisplayed manipulation icons 32-35 will go outside the view of the designer therefore ensuring that all of the manipulation icons 32-35 are always available to the designer. The manipulation icons 32-35 may also be rearranged to a different portion within the two-dimensional frame 30 thereby keeping the manipulation icons 32-35 visible to the designer when the designer moves the three-dimensional object 31 such that the redisplayed manipulation icons 32-35 start to go outside of the view or partially outside of the view of the display screen. For example, and in one exemplary embodiment of the present advancement, when the designer moves the three-dimensional object 31 to the right portion of the display screen such that one of the manipulation icons 33-35 that will be redisplayed upon deselecting the manipulation icon starts to go outside of the view of the display screen, the computer 2 move the arrangement of the manipulation icons 33-35 from a horizontal grouping on or below the three-dimensional object 31 to a vertical grouping on a left portion of the three-dimensional object 31 that is still visible on the display screen. The same features apply to manipulation icons 32-35 that are displayed around or over the three-dimensional object 31 when the two-dimensional frame 30 is not displayed. Further, the same features apply to other types of manipulation via the manipulation icons 32-35 that cause the three-dimensional object to be in a position such that redisplayed manipulation icons 33-35 will not be visible on the display screen.

The features of the present advancement described above allow a designer, regardless of his level of experience, to quickly grasp and understand the functionality required to manipulate three-dimensional objects. Further, as the manipulation icons always remain in the scene and are arranged in a manner that affords quick and direct access, the designer can perform faster manipulations on three-dimensional objects thereby increasing productivity and output. Further, the manipulation icons can be rearranged by the computer in an easy to access arrangement when the three-dimensional object is moved within the scene thereby providing constant direct access to their functionality while preventing their disappearance when a portion of the three-dimensional object is moved outside the view of the display screen.

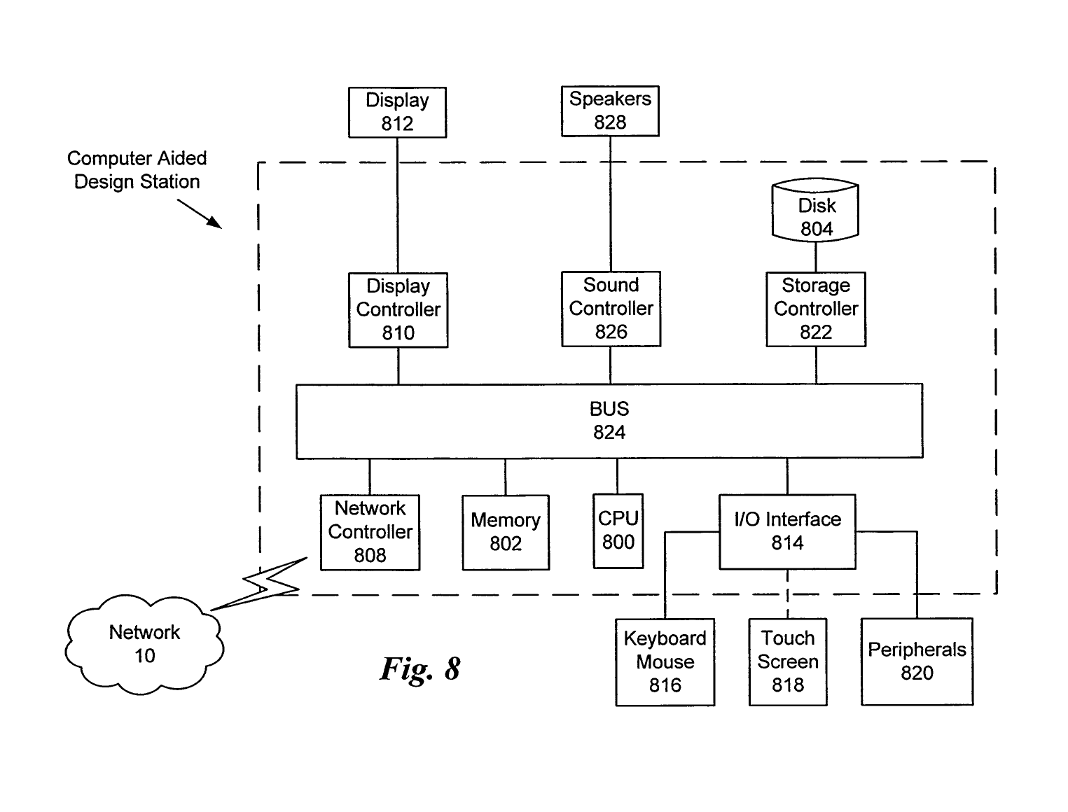

Next, a hardware description of the computer aided design station according to exemplary embodiments is described with reference to FIG. 8. In FIG. 8, the computer aided design station includes a CPU 800 which performs the processes described above. The process data and instructions may be stored in memory 802. These processes and instructions may also be stored on a storage medium disk 804 such as a hard drive (HDD) or portable storage medium or may be stored remotely. Further, the claimed advancements are not limited by the form of the computer-readable media on which the instructions of the inventive process are stored. For example, the instructions may be stored on CDs, DVDs, in FLASH memory, RAM, ROM, PROM, EPROM, EEPROM, hard disk or any other information processing device with which the computer aided design station communicates, such as a server or computer.

Further, the claimed advancements may be provided as a utility application, background daemon, or component of an operating system, or combination thereof, executing in conjunction with CPU 800 and an operating system such as Microsoft Windows 7, UNIX, Solaris, LINUX, Apple MAC-OS and other systems known to those skilled in the art.

CPU 800 may be a Xenon or Core processor from Intel of America or an Opteron processor from AMD of America, or may be other processor types that would be recognized by one of ordinary skill in the art. Alternatively, the CPU 800 may be implemented on an FPGA, ASIC, PLD or using discrete logic circuits, as one of ordinary skill in the art would recognize. Further, CPU 800 may be implemented as multiple processors cooperatively working in parallel to perform the instructions of the inventive processes described above.

The computer aided design station in FIG. 8 also includes a network controller 808, such as an Intel Ethernet PRO network interface card from Intel Corporation of America, for interfacing with network 10. As can be appreciated, the network 10 can be a public network, such as the Internet, or a private network such as an LAN or WAN network, or any combination thereof and can also include PSTN or ISDN sub-networks. The network 10 can also be wired, such as an Ethernet network, or can be wireless such as a cellular network including EDGE, 3G and 4G wireless cellular systems. The wireless network can also be WiFi, Bluetooth, or any other wireless form of communication that is known.

The computer aided design station further includes a display controller 810, such as a NVIDIA GeForce GTX or Quadro graphics adaptor from NVIDIA Corporation of America for interfacing with display 812, such as a Hewlett Packard HPL2445w LCD monitor. A general purpose I/O interface 814 interfaces with a keyboard and/or mouse 816 as well as a touch screen panel 818 on or separate from display 812. General purpose I/O interface also connects to a variety of peripherals 820 including printers and scanners, such as an OfficeJet or DeskJet from Hewlett Packard.

A sound controller 826 is also provided in the computer aided design station, such as Sound Blaster X-Fi Titanium from Creative, to interface with speakers/microphone 828 thereby providing sounds and/or music.

The general purpose storage controller 822 connects the storage medium disk 804 with communication bus 824, which may be an ISA, EISA, VESA, PCI, or similar, for interconnecting all of the components of the computer aided design station. A description of the general features and functionality of the display 812, keyboard and/or mouse 816, as well as the display controller 810, storage controller 822, network controller 808, sound controller 826, and general purpose I/O interface 814 is omitted herein for brevity as these features are known.

Any processes, descriptions or blocks in flowcharts described herein should be understood as representing modules, segments, or portions of code which include one or more executable instructions for implementing specific logical functions or steps in the process, and alternate implementations are included within the scope of the exemplary embodiment of the present advancements in which functions may be executed out of order from that shown or discussed, including substantially concurrently or in reverse order depending upon the functionality involved.

Obviously, numerous modifications and variations of the present advancements are possible in light of the above teachings. In particular, while the application of the present advancement has been described with respect to events such as conventions, sports and concerts, other applications are within the scope of the appended claims. For example, without limitation, the present advancement may be applied to video games, TV, cell phones, tablets, web applications, and any other platform as would be understood by one of ordinary skill in the art. It is therefore to be understood that within the scope of the appended claims, the present advancements may be practiced otherwise than as specifically described herein.

1. A method implemented by a computer aided design station for manipulating three-dimensional objects, comprising:
displaying, on a display screen,
at least one three-dimensional object in a scene, and
one or more manipulation icons based on a location of the at least one three-dimensional object in the scene, each manipulation icon corresponding to a different manipulating feature;
receiving a manipulation icon selection;
activating a manipulating feature corresponding to the selected manipulation icon; and
manipulating the at least one three-dimensional object based on the activated manipulating feature,
wherein the one or more manipulation icons are two-dimensional icons that always remain accessible after the manipulating step.

2. The method according to claim 1, wherein the activated manipulating feature manipulates the at least one three-dimensional object based on a two-dimensional interaction in a plane of the display screen.

3. The method according to claim 1, wherein the manipulating feature is a translational feature that provides movement of the at least one three-dimensional object from one location to another location within the scene.

4. The method according to claim 3, wherein the translational feature is performed with respect to a floor plane of the scene.

5. The method according to claim 1, wherein the manipulating feature is a rotational feature that provides rotation of the at least one three-dimensional object.

6. The method according to claim 5, wherein the rotational feature is performed with respect to an axis perpendicular to a floor plane of the scene.

7. The method according to claim 1, wherein the manipulating feature is a scaling feature that provides a change in a size of the at least one three-dimensional object.

8. The method according to claim 1, wherein the manipulating feature deletes the at least one three-dimensional object from the scene.

9. The method according to claim 1, wherein the displaying further includes displaying a two-dimensional frame surrounding the at least one three-dimensional object.

10. The method according to claim 9, wherein the two-dimensional frame is a rectangle.

11. The method according to claim 9, wherein a size of the two-dimensional frame is minimized based on a size of the three-dimensional object.

12. The method according to claim 9, wherein the two-dimensional frame and the one or more manipulation icons are not displayed while the at least one three-dimensional object is being manipulated.

13. The method according to claim 9, wherein the one or more manipulation icons are displayed within the two-dimensional frame.

14. The method according to claim 1, wherein the one or more manipulation icons are displayed in close proximity to the three-dimensional object or over the at least one three-dimensional object.

15. The method according to claim 1, wherein after manipulating the at least one three-dimensional object, the two-dimensional frame is redisplayed such that a size of the redisplayed two-dimensional frame is based on the manipulating.

16. The method according to claim 14, wherein after manipulating the at least one three-dimensional object, the one or more manipulation icons are redisplayed such that a size and arrangement of the redisplayed one or more manipulation icons is based on the manipulating.

17. The method according to claim 16, wherein, while the at least one three-dimensional object is being manipulated, the at least one three-dimensional object is prevented from being manipulated such that the at least one three-dimensional object is displayed at a position outside of a display portion of the display screen where the one or more redisplayed manipulation icons would not be visible.

18. The method according to claim 16, wherein the one or more redisplayed manipulation icons are rearranged in the scene such that the one or more redisplayed manipulation icons remain within the display portion of the display screen in response to the at least one three-dimensional object being manipulated such that the at least one three-dimensional object is displayed at a position outside of a display portion of the display screen.

19. A computer aided design station for manipulating three-dimensional objects, comprising:
a processor configured to
display, on a display screen,
at least one three-dimensional object in a scene, and
one or more manipulation icons based on a location of the at least one three-dimensional object in the scene, each manipulation icon corresponding to a different manipulating feature;
receive a manipulation icon selection;
activate a manipulating feature corresponding to the selected manipulation icon; and
manipulate the at least one three-dimensional object based on the activated manipulating feature,
wherein the one or more manipulation icons are two-dimensional icons that always remain accessible after the manipulating.

20. A non-transitory computer-readable medium storing computer readable instructions thereon that when executed by a processor cause the processor to perform a method for manipulating three-dimensional objects, comprising:
displaying
at least one three-dimensional object in a scene, and
one or more manipulation icons based on a location of the at least one three-dimensional object in the scene, each manipulation icon corresponding to a different manipulating feature;
receiving a manipulation icon selection;
activating a manipulating feature corresponding to the selected manipulation icon; and
manipulating the at least one three-dimensional object based on the activated manipulating feature,
wherein the one or more manipulation icons are two-dimensional icons that always remain accessible after the manipulating step.
